(19) United States
(12) Patent Application Publication
(10) Pub. No.: US 2015/0135091 A1
(43) Pub. Date: May 14, 2015

(54) DISPLAY APPARATUS AND CONTROLLING METHOD THEREOF

(71) Applicant: SAMSUNG ELECTRONICS CO., LTD., Suwon-si (KR)

(72) Inventors: Hee-kyoung SEO, Suwon-si (KR); Hee-won KU, Seoul (KR); Young-in PARK, Gunpo-si (KR); So-yon YOU, Seoul (KR); Youn-ji SHIM, Seoul (KR); Sung-jun HWANG, Suwon-si (KR)

(73) Assignee: SAMSUNG ELECTRONICS CO., LTD., Suwon-si (KR)

(21) Appl. No.: 14/539,425

(22) Filed: Nov. 12, 2014

(30) Foreign Application Priority Data
Nov. 13, 2013 (KR) 10-2013-0137520
Jan. 2, 2014 (KR) 10-2014-0000071
Apr. 30, 2014 (KR) 10-2014-0052494

(51) Int. Cl. G06F 3/0484; G06F 3/0482

(52) U.S. Cl. CPC G06F 3/04842; G06F 3/0482
USPC 715/745

(57) ABSTRACT

A display apparatus is disclosed. The display apparatus includes a display which displays a content, a user interface which receives user interaction regarding a content, and a controller which assigns at least one symbol item to the content based on the user interaction and provides the content from among a plurality of content based on the symbol item assigned to the content according to a predetermined event.

### CROSS-REFERENCE TO RELATED APPLICATIONS

This application claims priority from Korean Patent Application Nos. 10-2013-0137520, 10-2014-0000071, and 10-2014-0052494 filed in the Korean Intellectual Property Office on Nov. 13, 2013, Jan. 2, 2014, and Apr. 30, 2014, respectively, the disclosures of which are incorporated herein in their entireties.

### BACKGROUND

1. Field

Apparatuses and methods consistent with exemplary embodiments relate to a display apparatus and a controlling method thereof. In particular, exemplary embodiments relate to a display apparatus which is able to display a user preference for content, and a controlling method thereof.

2. Description of the Related Art

With the development of electronic technologies, various kinds of display apparatuses have been developed. In particular, display apparatuses, such as television (TVs), personal computers (PCs), laptops, tablet PCs, mobile phones, and MP3 players, have come into wide use to such an extent that they are used in most households.

Recently, to meet users' needs for new and varied functions, an effort is being made to develop display apparatuses in a new form. For example, a function by which a user inputs his/her preference for content provided on a display apparatus and receives various types of services according to the input preference is being vitalized.

However, according to the conventional art, it is impossible to provide a user with a variety of viewing experiences because conventional display apparatus only enables the user to input a user preference for a whole program or enables the user to input a user preference in the form of text.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

Aspects of the exemplary embodiments relate to a display apparatus which applies a user preference display to various types of attributes and provides various preference services, and a controlling method thereof.

According to an aspect of an exemplary embodiment, a display apparatus includes a display configured to display content, a user interface configured to receive user interaction regarding the content, and a controller configured to assign at least one symbol item to the content based on the user interaction and to provide the content from among a plurality of contents based on the symbol item assigned to the content.

According to another exemplary embodiment, the symbol item is at least one of a badge item that represents common attributes of at least one second content from among the plurality of contents and an emoticon item that represents emotions of a user.

According to another exemplary embodiment, the apparatus further includes a memory configured to store a history of the user interaction, where the controller is further configured to provide the badge item corresponding to at least one attribute of the at least one second content from among the plurality of contents based on the history, and in response to the badge item being selected, selects and provides at least one of the at least one second content corresponding to the badge item.

According to another exemplary embodiment, the badge item includes at least one of a content genre badge, a content program badge, a content cast badge, a content view pattern badge, and a check-in badge.

According to another exemplary embodiment, in response to a channel zapping command being input in a state in which the badge item is selected, the controller selects and provides a channel corresponding to the badge item.

According to another exemplary embodiment, user interaction comprises user input regarding at least one of the content itself, attributes of the content, and at least one object included in the content.

According to another exemplary embodiment, the apparatus further includes a communicator configured to communicate with a social networking service (SNS) server, where based on user interaction information of other users regarding the content, which is uploaded to the SNS server, the controller is further configured to provide feedback information of other users regarding the at least one second content corresponding to the badge item.

According to another exemplary embodiment, the controller is further configured to provide at least one of a user interface (UI) which is rotatable and provides a new badge item according to rotation, and a user interface (UI) which is scrollable and provides a new badge item according to scrolling on an area of the screen according to a predetermined event, and in response to a particular badge item being selected, displays corresponding content which belongs to the selected badge item.

According to another exemplary embodiment, in response to a particular badge item being selected in the UI, the controller is further configured to provide the corresponding content by selecting a channel that provides the content corresponding to the selected badge item.

According to another exemplary embodiment, in response to a UI screen that includes at least one emoticon item being displayed, and in response to the at least one emoticon item being selected based to the user interaction, the controller assigns information corresponding to the selected emoticon item to the displayed content.

According to another exemplary embodiment, the controller displays the UI screen that groups the emoticon items based on attributes of the emoticon items on an area of the display.

According to another exemplary embodiment, the controller is further configured to receive information regarding the content and an emoticon selected regarding the content by other user from an external server based on a predetermined event, and displays the received information on a predetermined area of the display.

According to another exemplary embodiment, the controller is further configured to receive information on a number of other users who select an emoticon item for the content, and is further configured to display the number of the other users on the predetermined area.

According to another exemplary embodiment, the controller is further configured to provide the content by displaying the symbol item on an area of a thumbnail based on the predetermined event.

According to another exemplary embodiment, the controller is further configured to provide at least one of the symbol item and text information corresponding to the symbol item on an area of the display which displays the content.

According to an aspect of another exemplary embodiment, a method of controlling a display apparatus includes displaying content, receiving user interaction regarding the content; and assigning at least one symbol item to the content based on the user interaction, and providing the content from among a plurality of contents based on the symbol item assigned to the plurality of contents.

According to another exemplary embodiment, the symbol item is at least one of a badge item that represents common attributes of at least one second contents from among the plurality of contents and an emoticon that represents emotions of a user.

According to another exemplary embodiment, the method further includes storing a history of the user interaction, where the providing at least one first content comprises providing the badge item corresponding to at least one attribute of the at least one second content based on the history, and in response to the badge item being selected, selecting and providing at least one of the at least one second content corresponding to the badge item.

According to another exemplary embodiment, the method further includes, in response to a channel zapping command being input in a state in which the badge item is selected, selecting and providing a channel corresponding to the badge item.

According to another exemplary embodiment, the providing a content comprises providing at least one of a user interface (UI) which is rotatable and provides a new badge item according to rotation, and a user interface which is scrollable and provides a new badge item according to a movement on an area of the screen according to a predetermined event, and in response to a particular badge item being selected, displays corresponding content which belongs to the selected badge item.

According to an aspect of another exemplary embodiment, a method of controlling a display apparatus includes displaying content, receiving user input representing a user's emotion towards an attribute of the content, and storing the received user input.

According to another exemplary embodiment, the method further includes assigning at least one symbol item to the content based on the user input.

According to another exemplary embodiment, the method further includes selecting the content from among a plurality of contents based on respective symbol items assigned to the plurality of content, and providing the selected content to a user.

According to another exemplary embodiment, the assigning the at least one symbol item comprises assigning the displayed content to a group of other contents that share similar attributes with the displayed content.

According to an aspect of another exemplary embodiment, a display apparatus includes a display configured to display content, a user interface configured to receive user input representing a user's emotion towards an attribute of the content, and a memory configured to store the received user input.

According to another exemplary embodiment, the display apparatus further includes a controller configured to assign at least one symbol item to the content based on the user input.

According to another exemplary embodiment, the controller is further configured to select the content from among a plurality of contents based on respective symbol items assigned to the plurality of content and to provide the selected content to a user.

According to another exemplary embodiment, assigning the at least one symbol item comprises assigning the displayed content to a group of other contents which share similar attributes with the displayed content.

According to the above-described diverse exemplary embodiments, a user preference display may be applied to various types of attributes of a content. In addition, by assigning an emoticon a user wants to a displayed content, emotions of the user for the content may be displayed immediately. Accordingly, a larger amount of viewing experiences may be provided to the user.

Additional and/or other aspects and advantages will be set forth in part in the description which follows and, in part, will be obvious from the description, or may be learned by practice of the different exemplary embodiments.

### BRIEF DESCRIPTION OF THE DRAWINGS

The above and/or other aspects will be more apparent by describing certain exemplary embodiments with reference to the accompanying drawings, in which:

FIGS. 1A and 1B illustrate display systems according to exemplary embodiments;

FIGS. 2A and 2B are block diagrams illustrating a configuration of a display apparatus according to an exemplary embodiment;

FIGS. 3A to 3E illustrate examples of a badge item according to exemplary embodiments;

FIG. 4 illustrates a method of inputting a check-in interaction according to an exemplary embodiment;

FIG. 5 illustrates a method of inputting a check-in interaction according to another exemplary embodiment;

FIGS. 6A to 6C illustrate functions of a badge item according to exemplary embodiments;

FIGS. 7A to 7D illustrate a method of providing a content according to another exemplary embodiment;

FIG. 8 illustrates a method of reflecting a user's opinion for content according to an exemplary embodiment;

FIGS. 9A to 9C illustrate a method of inputting a check-in interaction for assigning an emoticon according to another exemplary embodiment;

FIGS. 10A and 10B illustrate a method of categorizing emoticons according to an exemplary embodiment;

FIGS. 11A and 11B illustrate a method of providing information on content according to an exemplary embodiment;

FIG. 12 illustrates a method of updating emoticon information according to an exemplary embodiment;

FIG. 13 illustrates a method of providing a reward according to an exemplary embodiment;

FIGS. 14A and 14B illustrate a method of providing a user interface (UI) according to an exemplary embodiment;

FIG. 15 is a flow chart illustrating a controlling method of a display apparatus according to an exemplary embodiment; and

FIG. 16 is a flow chart illustrating a controlling method of a display apparatus according to another exemplary embodiment.

### DESCRIPTION OF THE PREFERRED EMBODIMENT

Hereinafter, certain exemplary embodiments will be described in greater detail with reference to the accompanying drawings.

In the following description, same drawing reference numerals are used for the same elements even in different drawings. The matters defined in the description, such as detailed construction and elements, are provided to assist in a comprehensive understanding. Thus, it is apparent that the exemplary embodiments can be carried out without those specifically defined matters. Also, well-known functions or constructions are not described in detail because they would obscure the exemplary embodiments with unnecessary detail.

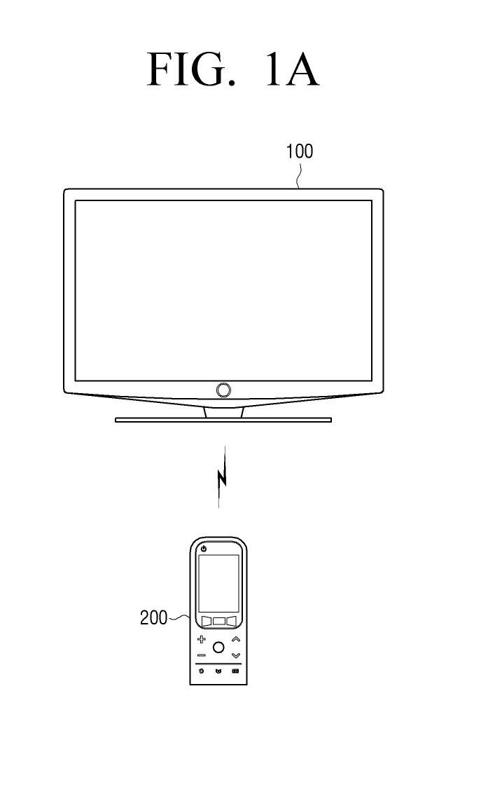

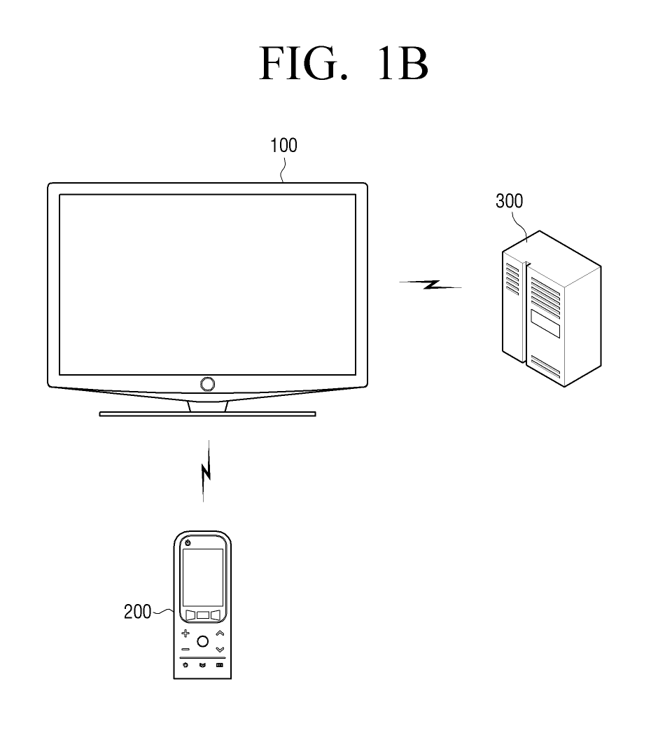

FIG. 1A illustrates a display system according to an exemplary embodiment.

Referring to FIG. 1A, a display system according to an exemplary embodiment includes a display apparatus 100 and a remote control apparatus 200.

The display apparatus 100 may be embodied as a digital TV as shown in FIG. 1, but is not limited thereto. The display apparatus 100 may be embodied as various other types of apparatuses with display functions, such as a PC, a cellular phone, a tablet PC, a portable multimedia player (PMP), a personal digital assistant (PDA), or a navigation device. When the display apparatus 100 is embodied as a portable apparatus, the display apparatus 100 may be equipped with a touch screen so that a user may execute a program by using a finger or a pen (for example, a stylus pen). However, hereinafter, for the purpose of convenience, the display apparatus 100 will be embodied as a digital TV.

The display apparatus 100 may be controlled by a motion from a user, voice of the user, or the remote control apparatus 200. The remote control apparatus 200, as an apparatus to remotely control the display apparatus 100, may receive a user command and transmit a control signal corresponding to the received user command to the display apparatus 100. The remote control apparatus 200 may be embodied in various forms, such as an apparatus which senses movements of the remote control apparatus 200 and transmits a signal corresponding to the movements, an apparatus that recognizes a voice and transmits a signal corresponding to the voice, or an apparatus that transmits a signal corresponding to the received key (for example, a plurality of color buttons). In this regard, the remote control apparatus 200 may be embodied to include a motion sensor, a touch sensor or an Optical Joystick sensor (OJ), a physical button (for example, a Tact Switch), a display screen, and/or a microphone in order to receive various kinds of user commands.

The display apparatus 100 may provide various types of user interface (UI) screens based on a user command input through the remote control apparatus 200. In addition, the display apparatus 100 may provide a variety of functions and information according to various types of user interaction for the UI screens.

In particular, the display apparatus 100 may provide a badge item, which makes it possible to categorize contents according to a predetermined standard based on user interaction and provide the contents. This will be explained later in greater detail with reference to a block diagram depicting a detailed configuration of the display apparatus 100.

FIG. 1B illustrates a display system according to another exemplary embodiment.

According to FIG. 1B, the display system includes the display apparatus 100, the remote control apparatus 200, and a server 300.

The external server 300 may be installed with an Operating System (OS), which the display apparatus 100 needs, and may support an information providing function for the display apparatus 100. Here, information provided by the server 300 may include content, information on the content, an emoticon, and information on the emoticon. The display apparatus 100 is connected to the external server 300 through a communication network, such as an Internet protocol (IP) network, and may receive content, information on the content, an emoticon, and information on the emoticon from the external server 300. The external server 300 may calculate a user preference for a scene of content based on various types of information. Hereinafter, detailed description of information the display apparatus 100 receives from the external server 300 will be described.

The display apparatus 100 may categorize emoticons based on user interaction according to a predetermined standard, and provide the emotions. Hereinafter, various exemplary embodiments will be explained with reference to a block diagram that illustrates a detailed configuration of the display apparatus 100.

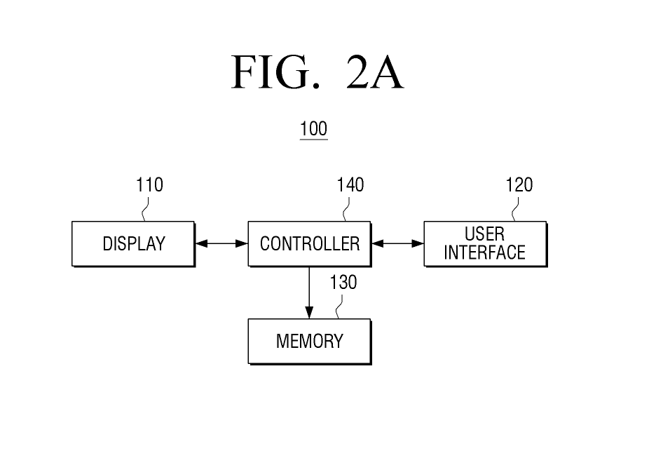

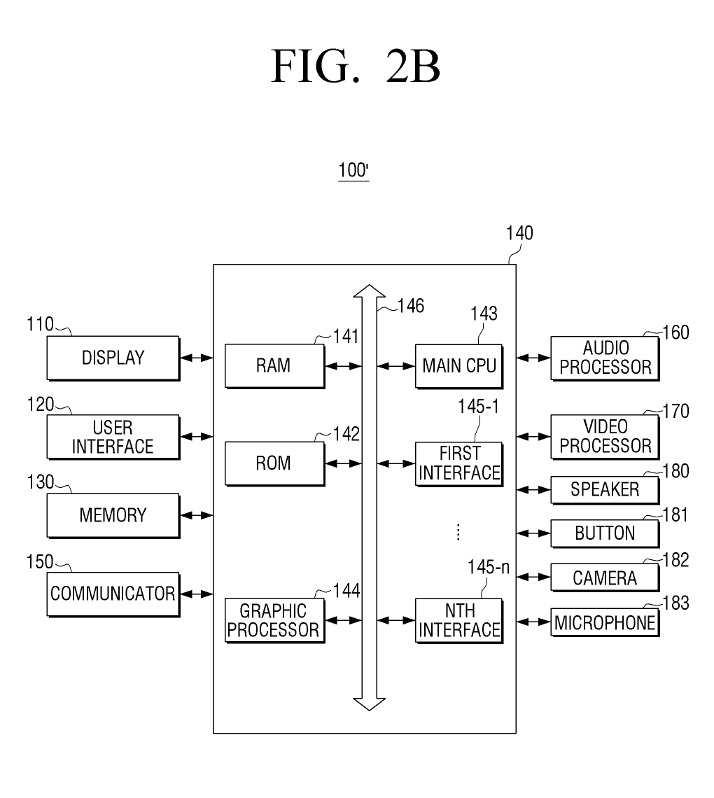

FIG. 2A is a block diagram illustrating a configuration of a display apparatus 100 according to an exemplary embodiment.

Referring to FIG. 2A, the display apparatus 100 includes a display 110, a user interface 120, a memory 130, and a controller 140.

The display 110 displays a variety of screens. In this regard the display may include a content playback screen which plays a variety of content such as an image, a video, text, music, etc., an application execution screen that includes a variety of content, a web browser screen, and a Graphic User Interface (GUI).

The display 110 may be embodied as a Liquid Crystal Display (LCD) panel, an Organic Light Emitting Diodes (OLED), etc., but is not limited thereto. Furthermore, the display 110 may be embodied as a flexible display or a transparent display in some cases.

The display 110 displays a content playback screen. According to an exemplary embodiment, the display 110 may display a real-time broadcast content screen.

The user interface 120 receives different types of user commands. Herein, the user interface 120 may be embodied in various forms depending on an exemplary embodiment of the display apparatus 100. When the display apparatus 100 is embodied as a digital TV, the user interface 110 may be embodied as a remote controller receiver that receives a signal of a remote controller from the remote control apparatus 200, a camera that senses a motion of a user, and/or a microphone that receives a voice of the user. In addition, when the display apparatus 100 is embodied as a touch-based portable terminal, the user interface 120 may be embodied as a touch screen that is mutually layered with a touchpad. In this regard, the user interface 120 may be used as the above-described display 110.

Particularly, the user interface 120 may receive user interaction regarding content displayed on the display 110.

Specifically, the user interface 120 may receive user interaction (hereinafter, referred as a check-in interaction) that represents a preference display regarding content, for example, a real-time broadcast content, and user interaction that assigns an emoticon embodied as an icon that shows emotions of a user for the real-time broadcast content. In this regard, the user interaction may not only be input via a predetermined button equipped in the remote control apparatus 200, but may also be input via various types of touch manipulations, a predetermined voice of the user, or a predetermined motion of the user. As an example, the user interaction may be a user voice saying “like” or a user motion form drawing “ [symbol] ”. Furthermore, the types of user interactions may include a history of viewing and listening, which is automatically recognized by a device (for example, view and listen for more than 10 minutes), and may include a registration of a user preference (for example, a motion of adding a content to a list of preferences.)

In this regard, a preference display for a content, and an emoticon selection for the content may be applied not only to the content itself, but may also be applied to different types of attributes composing the content and/or an object. For example, a preference display for different kinds of objects, such as a program, an episode, a broadcasting time, a scene, a cast, a character, an item, an emotion, an image, a background screen, and sound, may be automatically applied. In this regard, a selected emoticon may be for displaying estimated emotions and feelings of a user for the corresponding content. For example, the display apparatus 100 may receive various kinds of emoticons, which represent emotions of joy, sadness, anger, surprise, and boredom from the external server 300, and a user may select an emoticon from such emoticons to assign to displayed content. Besides, the selected emoticon may be unrelated to emotions and feelings of the user for the corresponding content. For example, the display apparatus 100 may display at least one emoticon that is irrelevant to a genre of the displayed content and other user's estimation. In this regard, the emoticon assigned by the user to a particular content may be unrelated to a genre of the corresponding content or a user's estimation, according to an exemplary embodiment.

In addition, the user interface 120 may receive check-in interaction for at least one attribute from among attributes of a real-time broadcast content and an object included in the real-time broadcast content, according to another exemplary embodiment.

For example, the user may select a sub genre of the displayed content and input check-in interaction, or select a character included in the displayed content and input the check-in interaction.

The memory 130 stores a history of the user interaction inputted through the user interface 120.

Specifically, in response to an input of check-in interaction for a real-time broadcast content, the corresponding input information may be accumulated and stored in the memory 130.

If check-in interaction for at least one attribute from among attributes of a real-time broadcast content and an object included in the real-time broadcast content is input, the memory 130 may accumulate and store the corresponding input information. In addition, if check-in interaction for at least one attribute from among attributes of a content and an object included in the content is input, the storage 130 may accumulate and store the corresponding input information.

The controller 140 controls an overall operation of the display apparatus 100.

Check-in Interaction

Particularly, the controller 140 may provide an item corresponding to at least one attribute of a content based on a history of check-in interaction stored in the memory 130. In this regard, the attribute of the content may be a program itself, an episode of the program, a subgenre (for example, baseball, or a real variety show), a broadcasting time, a cast, a character, an item, an emotion, an image, a background screen, sound, a scene, etc. Here, the subgenre may be distinguished based on a wider category (for example, sports, entertainment, a drama, etc.) provided by Electronic Program Guide (EPG) information.

As an exemplary embodiment, an item may be a badge item that symbolically represents common attributes of at least one content, which belongs to the corresponding item, and may be provided in a form of an icon.

Specifically, the badge item may include at least one from among a content genre badge, a content program badge, a content cast badge, a content view pattern badge, and a check-in badge that shows at least one attribute of a content, but is not limited thereto.

For example, in response to the check-in interaction being input for a predetermined number of times for a real-time broadcast content, a first badge item corresponding to a genre of the corresponding broadcast content and a second badge item corresponding to a character of the corresponding broadcast content may be provided.

In this regard, attributes of a content for providing a badge item may be set as a default, or may be selected or changed by the user. Furthermore, the attributes of the content may be determined by meta data included in the content.

In addition, the badge item may be pre-produced and stored in the display apparatus 100 or may be automatically generated according to the attributes of the content. Moreover, the badge item may be produced or modified by the user.

If attributes of a content or an object is selected while check-in interaction is input, controller 140 may provide a badge item only for the corresponding attributes or the object. For example, in response to the check-in interaction being input after a character of a real-time broadcast content is selected, only a badge item corresponding to the selected character may be provided.

Meanwhile, the controller 140 may provide a badge item based on a variety of detailed conditions. Specifically, a badge item may be provided according to various conditions, such as the number of times a simple check-in interaction was input, as well as the number of times a check-in interaction was input according to a degree of concern and the number of times badge items were issued, the number of times the check-in interaction was input within a predetermined period of time, the number of times consecutive check-in interaction was input, the number of times check-in interaction was input in order of arrival, and the frequency of input of acquaintances' simultaneous check-in interaction. Accordingly, the user may be able to obtain different types of badge items through a preference display for the content.

In addition, if a particular badge item is pre-provided to the user, the controller 140 may level up the corresponding badge item according to the predetermined conditions, and provide the corresponding badge item.

In addition, if at least one badge item is selected according to a predetermined event, the controller 140 may select and provide only content that belongs to the selected badge item. For example, if a user command for displaying a badge is input, the controller 140 may display a badge item assigned to at least one or more contents, and if a particular badge item is selected, the controller 140 may provide content that belongs to the selected badge item.

Specifically, if a channel zapping command is input after a particular badge item is selected, the controller 140 may select and display only channels corresponding to the badge item.

In addition, the controller 140 may arrange contents corresponding to the selected badge item in order, and display the corresponding contents. In this regard, the contents may be arranged in order based on priority according to the number of times a check-in interaction was input for each of the contents.

If the predetermined conditions are met based on a history of the check-in interactions stored in the memory 130, the controller 140 may increment a level of a badge item and provide a predetermined point that increments the level of the badge item. For example, if the number of times a check-in interaction was input for a particular broadcast program exceeds the predetermined number, a level of the badge item for the corresponding broadcast program is incremented p and 5 points are provided, according to an exemplary embodiment.

In this regard, the controller 140 may provide an event badge item based on the points. Here, the event badge item is a badge item that may be used for a predetermined period of time, and may be, for example, a Christmas badge item, and a Thanksgiving Day badge item, etc.

The controller 140 may assign the corresponding event badge item based on the check-in interaction while the event badge item is activated. As an example, if the Christmas badge item is provided, and if check-in interaction for the content is input, it is determined whether the content is related to Christmas, and the corresponding badge item may be provided, depending on the determination. Accordingly, the user may be provided with contents related to Christmas through the Christmas badge items for a particular period of time.

The controller 140 also may provide various kinds of rewards, such as a video on demand (VOD) coupon, other than an event badge item, based on the points.

In this case, the controller 140 may provide a reward, such as an event badge item or a VOD coupon according to a point accumulation rate, but in some cases, the reward, such as the event badge item or the VOD coupon, may be provided by lot. For instance, the controller 140 may provide a reward by drawing lots for a Lucky box, which is a kind of a point provided every time a level of a badge is incremented.

The controller 140 may provide a badge item, which is provided as a default, based on user information regardless of the user's check-in interaction. Herein, the default badge item may be a generation (or an age) and a gender badge item, a preference badge item, a recommendation badge item, and a genre badge item. For example, the generation and the gender badge item may be a badge item, such as kids, woman between the age of 20-30, and man between the age of 50-60. The preference badge item may provide an interesting program designated by the user. The recommendation badge item may provide an interesting program recommended based on the user information (for example, a gender, and an age), and the genre badge item may be provided based on classification of genre (for example, sports and entertainment) according to EPG. In addition, the check-in badge, which provides a content according to an order of priority based on the number of times a real-time check-in interaction was input, may be provided.

In addition, the controller 140 may recommend a content based on a badge item the user possesses, and for the recommended content, may provide a badge item, which is a basis for recommendation with the recommended content. For example, for a viewer who has possesses a badge item for a particular program, an episode of the program the viewer has not watched may be recommended or a new program recently added to the badge item may be recommended.

The controller 140 may receive and reflect the user's opinion in a poll form for contents that belong to the badge item and may provide other users' opinions. Specifically, opinions on various attributes of a content, such as a scene, an actor, an episode, a director, music and/or an object, may be reflected or provided.

The controller 140 may provide information on the number of other users who displayed their preferences for the same object. For instance, information regarding the number of viewers simultaneously watching the corresponding episode of a drama and the number of viewers who input check-in interaction for a character of the corresponding scene may be provided.

Also, the controller 140 may display a history of preference of a particular user. In this regard, the particular user may recognize the history through logging-in to the user's own account, or through a technology of recognizing other users. The controller 140 may process a history of preference display of the particular user to organize and provide a viewing pattern and a matter of interest, or to recommend new content.

<Emoticon Assignment

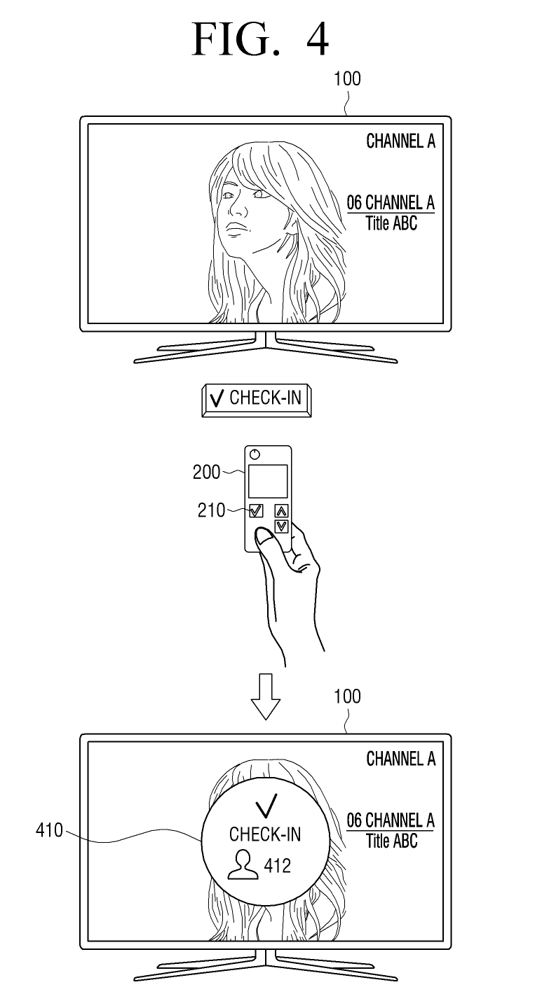

The controller 140 may display a check-in screen 410, as shown in FIG. 4 on one side of a display screen while the controller 140 is displaying content. The check-in screen 410 may be a Graphic User Interface (GUI) for assigning an emoticon to the content.

Meanwhile, the controller 140 may display at least one emoticon. In this regard, the controller 140 may display an emoticon on the check-in screen 410 that is displayed on one side of a display screen. In addition, if the check-in screen 410 is displayed, a selection object 412, as shown in FIG. 4, for one emoticon may be positioned.

In this regard, the selection object 412 may be displayed on a GUI that shows one of at least one or more selected emoticons, and may be implemented in various forms, for example, a cursor. The user may dispose the selection object 412 on an emoticon which the user wants to select from a plurality of emoticons and an emotion may be selected through various kinds of control signals, such as a remote controller 200 signal, a user voice signal, or a user motion signal.

In this regard, the emoticon may be received from the external server 300 in real-time, and may be stored in a storage medium after receiving the emoticon from the external server 300. Besides, the emoticon may be captured, produced directly, or modified by the user, and stored in the storage medium.

However, in response to one of at least one or more emoticons being selected according to the received user command, the controller 140 may assign information on the selected emoticon to the content. If the information on the emotion selected by the user is added to the information on the content, the controller 140 may display the emoticon selected by the user on a thumbnail that corresponds to the corresponding content.

The controller 140 may assign an emoticon to at least one from among a content, attributes of the content, and at least one object included in the content. For example, if the user inputs check-in interaction for various objects, such as each episode of the content, a broadcasting time, a cast, a character, an item, an emotion, an image, a background screen, sound, etc., the controller 140 may input an emoticon selected by the user for the individual objects.

Meanwhile, the controller 140 may receive content and information on the content from the external server 300 according to a predetermined event. In addition, the controller 140 may receive information on an emoticon selected by other users for the content. That is, the controller 140 may receive information on whether other users assigned an emoticon to a particular content, what kind of emoticon the other users assigned, and the number of other users who assigned an emoticon to the particular content. Subsequently, the controller 140 may display the received information on a predetermined area of the display.

FIG. 2B is a block diagram illustrating a detailed configuration of the display apparatus 100 according to another exemplary embodiment. Referring to FIG. 2B, the display apparatus 100 includes the display 110, the user interface 120, the memory 130, the controller 140, a communicator 150, an audio processor 160, a video processor 170, a speaker 180, a button 181, a camera 182, and a microphone 183. Hereinafter, some of the elements illustrated in FIG. 2B previously described with reference to FIG. 2A will not be described in detail.

The controller 140 controls an overall operation of the display apparatus 100 by using a variety of programs stored in the memory 130.

Specifically, the controller 140 includes a Random Access Memory (RAM) 141, a Read Only Memory (ROM) 142, a main Central Processing Unit (CPU) 143, a graphic processing unit 144, interfaces 145-1˜145-n, and a bus 146.

The RAM 141, the ROM 142, the main CPU 143, the graphic processing unit 144, and the interfaces 145-1˜145-n may be connected with each other through the bus 146.

The interfaces 145-1˜145-n are connected with all the above described elements. One of the interfaces may be a network interface connected to an external apparatus through a network.

The main CPU 143 accesses the memory 130 and performs booting by using an Operating System (O/S) stored in the memory 130. The main CPU 143 may perform a variety of operations by using programs, contents, and data stored in the storage 130.

A set of commands to boot the system are stored in the ROM 142. When a turn on command is input and power is supplied, the main CPU 143 copies an operating system (O/S) stored in the memory 130 into the RAM 141 according to a command stored in the ROM 142, and boots the system by executing the O/S. When the booting is completed, the main CPU 143 copies the various application programs stored in the memory 130 into the RAM 141, and performs various operations by executing the various kinds of applications copied into the RAM 141.

The graphic processor 144 generates a screen including various objects, such as an icon, an image, and text using a calculator and a renderer. The calculator calculates attribute values of each object to be displayed, such as coordinate values, a shape, a size, and a color, according to a layout of the screen using the received control command. The renderer generates a screen in various layouts including objects based on the attribute values calculated by the calculator. The screen generated by the renderer is displayed on a display area of the display 110.

The above-described operations of the controller 140 may be performed by executing a program stored in the memory 130.

The memory 130 stores data, such as an operating system (O/S) software module to run the display apparatus 100, all sorts of multimedia content, applications, and content input or set while applications are running.

The communicator 150 performs communication with an external apparatus according to various types of communication methods.

Particularly, the communicator 150 may communicate with a social network service (SNS) server. In this regard, the communicator 150 may include different kinds of communication chips such as a WiFi-chip, a Bluetooth chip, a wireless communication chip, a near field communication (NFC) chip, etc.

In this case, based on interaction information of other users on a content that belongs to a badge item uploaded to the SNS server, the controller 140 may provide feedback information on the content from other users. For example, when a user selects a particular program through a particular badge item and there is information of other users' likings towards the corresponding program, the corresponding content may be displayed. Accordingly, the user may check the feedback information of the different users with respect to the selected program.

The communicator 150 may control the display 110 to receive a content and/or information on the content from the external server 300, and to display the content by parsing the received content information.

In addition, the user may input an emoticon for a displayed content by the communicator 150 receiving the emotion and/or information on the emoticon from an external server 300, and by the controller 140 controlling the display 110 to display the received emoticon.

The audio processor 160 is an element that processes audio data. The audio processor 160 may perform various types of processing, such as decoding, amplifying, and noise filtering with respect to audio data. For example, if there is a check-in interaction, the audio processor 160 may generate and provide a feedback sound corresponding to an interaction that a badge item is selected, according to an exemplary embodiment.

The video processor 170 is an element that processes video data. The video processor 170 may perform various types of image processing, such as decoding, scaling, noise filtering, frame rate converting, and resolution converting with respect to video data.

The speaker 180 is an element that outputs, not only all types of audio data processed in the audio processor 160, but also various kinds of alarming sounds or voice messages, but is not limited thereto.

The button 181 may be one of the variety of buttons, such as a mechanical button, a touch button, a wheel formed in an arbitrary area, such as a front surface, a side surface, a rear surface of the exterior of the main body of the display apparatus 100, but is not limited thereto. For example, a button for toggling the power of the display apparatus 100 may be incorporated.

The camera 182 is configured to photograph a static image or a video according to a control of the user. Particularly, the camera 182 may photograph motions of the user to control the display apparatus 100.

The microphone 183 is configured to receive a voice or other sounds of the user to control the display apparatus 100 and convert the sound into audio data. The controller 140 may convert a voice of the user received through the microphone 183 into audio data and use the audio data for controlling the display apparatus 100. Meanwhile, the camera 182 and the microphone 183, depending on the function, may be a part of the above-described user interface 120, according to another exemplary embodiment.

If the camera 182 and the microphone 183 are incorporated, the controller 140 may perform a controlling operation according to a voice of the user received through the microphone 183 and/or a motion of the user recognized by the camera 182. In other words, the display apparatus 100 may operate in a motion control mode and/or a voice control mode. If the display apparatus 100 operates in the motion control mode, the controller 140 picks up the user's actions by activating the camera 182, and by tracking a change of the motion of the user, performs a control operation corresponding to the motion of the user. If the display apparatus 100 operates in the voice control mode, the controller 140 may analyze the voice of the user input through the microphone 183, and perform a control operation corresponding to the analyzed voice of the user.

Various external input ports to connect to different kinds of external terminals such as a headset, a mouse, and a local area network (LAN) may further be included.

FIG. 2B is an example of a detailed configuration included in the display apparatus (100), and depending on an exemplary embodiment, a part of the elements shown in FIG. 2B may be omitted or changed, and other elements may further be added.

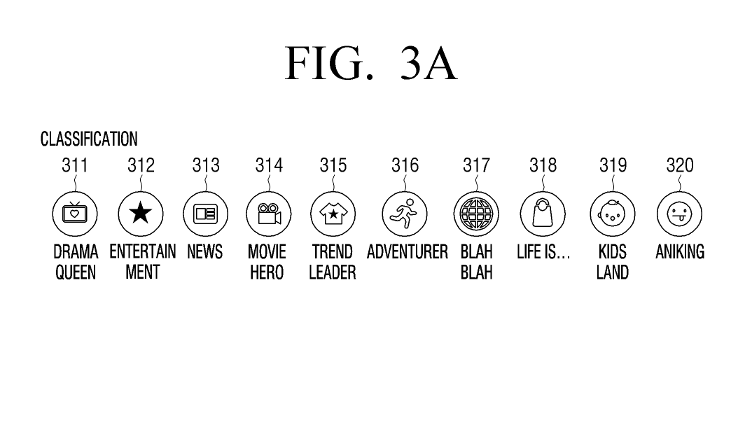

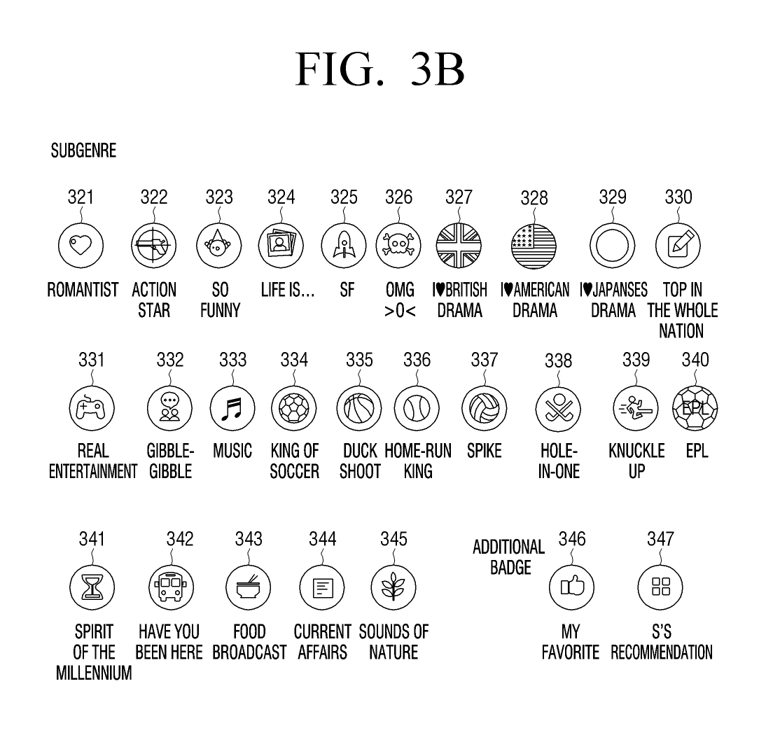

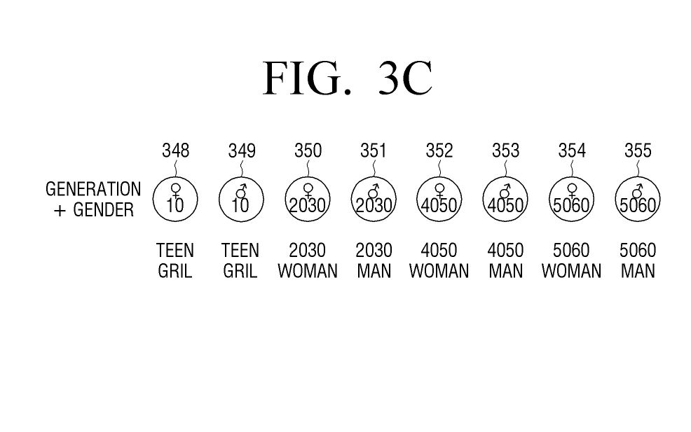

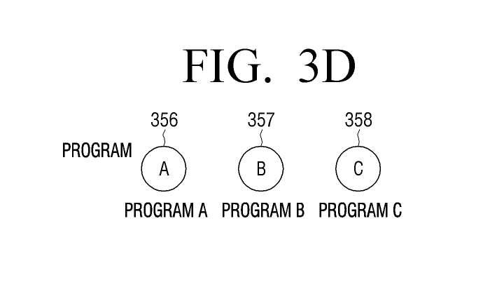

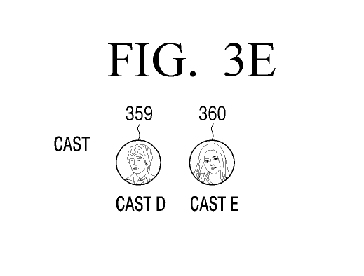

FIGS. 3A to 3E illustrate examples of various badge items according to exemplary embodiments.

FIG. 3A illustrates badge items classified based on various standards. For example, there may be “Drama Queen” badge item 311, which represents a drama genre, and “News” badge item 313, which represents a news genre. Several other badge items may be available, such as “Entertainment” 312, “Movie Hero” 314, “Trend Leader” 315, “Adventurer” 316, “Blah Blah” 317, “Life Is . . . ” 318, “Kids Land” 319 and “Aniking” 320, but are not limited thereto.

FIG. 3B depicts a subgenre, that is, a view illustrating badge items classified according to a sub category of EPG-based genre. For example, there may be “Romantist” badge item 321, which represents a romantic drama genre which is a sub genre of drama, and a “American drama” badge item 328 representing American dramas. Other sub-category genre based badge items include“Action Star” 322, “So Funny” 323, “Life Is . . . ” 324, “SF” 325, “OMG” 326, “British Drama” 327, Japanese Drama “329”, “Top In The Whole Action” 330, “Real Entertainment” 331, “Gibble Gibble” 332, “Music” 333, “King Of Soccer” 334, “Duck Shoot” 335, “Home-Run King” 336, “Spike” 337, “Hole In One” 338, “Knuckle Up” 339, “EPL” 340, “Spirit Of The Millenium” 341, “Have You Been Here” 342, “Food Broadcast” 343, “Current Affairs” 344, and “Sounds of Nature” 345, but are not limited thereto. There might be other badge items classified based on user taste as shown in FIG. 3B. For example, there might be a Badge item “My Favorite” 346 representing content previously liked by the user and another badge item “S's Recommendation” 347 representing content recommended by user S, according to an exemplary embodiment.

FIG. 3C is a view illustrating badge items classified according to a generation and/or a gender. For example, there may be “Teen girls” badge item 348 that represents contents related to teenage girls, “5060 man” 355 badge item that represents contents related to male viewers between the age of 50 to 69/70. Other generation and/or gender based badge items that might be available are “Teen Boy” 349, “2030 Woman” 350, “2030 Man” 351, “4050 Woman” 352, “4050 Man” 353, and “5060 Woman” 354, but are not limited thereto.

FIG. 3D is a view illustrating badge items classified by program, namely “Program A” 356, “Program B” 357, and “Program C” 358 according to an exemplary embodiment.

FIG. 3E is a view illustrating badge items classified by cast, namely “Cast D” 359, and “Cast E” 360, according to an exemplary embodiment.

The badge items illustrated in FIGS. 3A to 3E may be provided as a default in the display apparatus 100, may be issued based on a history of a check-in interaction or various other events, or may be directly produced by a user.

FIG. 4 illustrates a method of inputting a check-in interaction according to an exemplary embodiment.

As shown in FIG. 4, if a particular program is being aired, a user may input a check-in interaction through a predetermined button 210 incorporated in the remote control apparatus 200 or a touch pad. However, the check-in interaction may be input by a voice of a user or a motion of a user, according to an exemplary embodiment.

In this case, the GUI 410 that shows that the check-in interaction is input may be displayed overlapping the content being displayed on the display. The GUI 410 may display at least one from among the number of users who checked in to the corresponding program and the number of users who checked in to an episode of the program being aired. Meanwhile, an audio feedback, which gives the user feedback on the input check-in interaction may be provided, according to an exemplary embodiment.

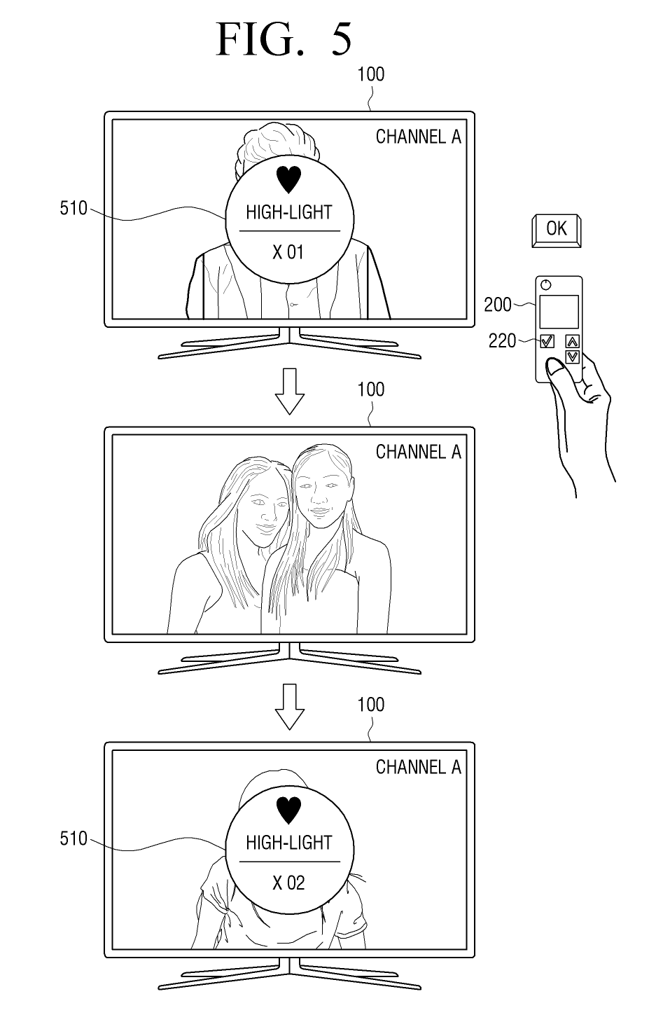

FIG. 5 illustrates a method of inputting check-in interaction according to another exemplary embodiment.

As shown in FIG. 5, a check-in interaction may be input, not only with respect to a program, but also with respect to each scene of the program.

Specifically, as illustrated, if a particular program is being aired, a user may input a check-in interaction in a particular scene through a predetermined button or a touch pad equipped in the remote control apparatus 200. In this regard, the check-in interaction maybe input in a way different from the check-in interaction for a program, described in FIG. 4. The check-in interaction for a particular scene may be input through a different button 220, a different motion, or a different voice from that described in FIG. 4, according to an exemplary embodiment.

In this case, the GUI 510, which shows that the check-in interaction for a particular scene has been input, may be displayed overlapping the content being displayed on the display. The GUI 510 may include the number of times of the check-in interaction has been input for the particular scene of the program. For example, referring to the display apparatus 100 shown beneath the lowest arrow in FIG. 5, along with the check-in interaction for a particular scene, a number that indicates that the check-in interaction was input twice for the particular scene of the program may be included in the GUI 510 displayed on the screen.

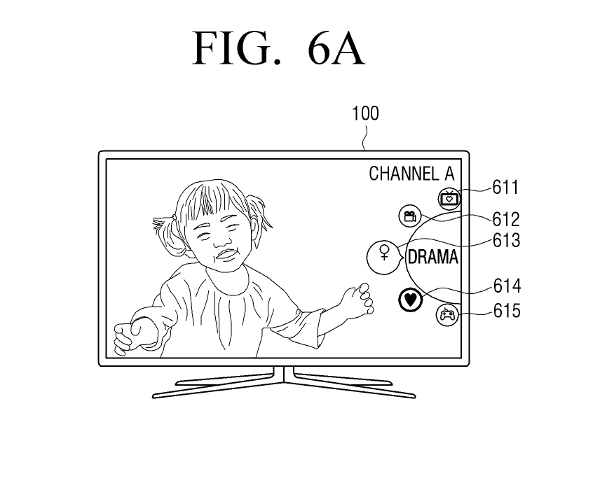

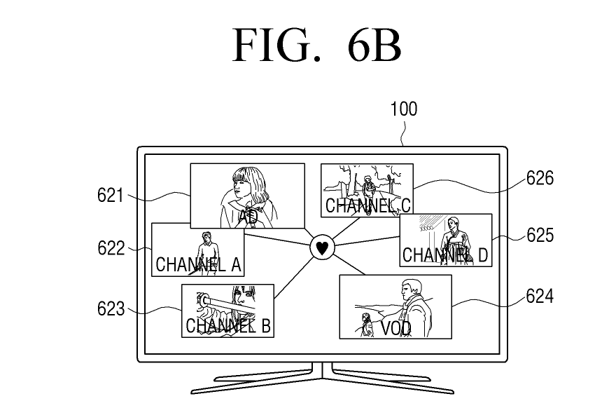

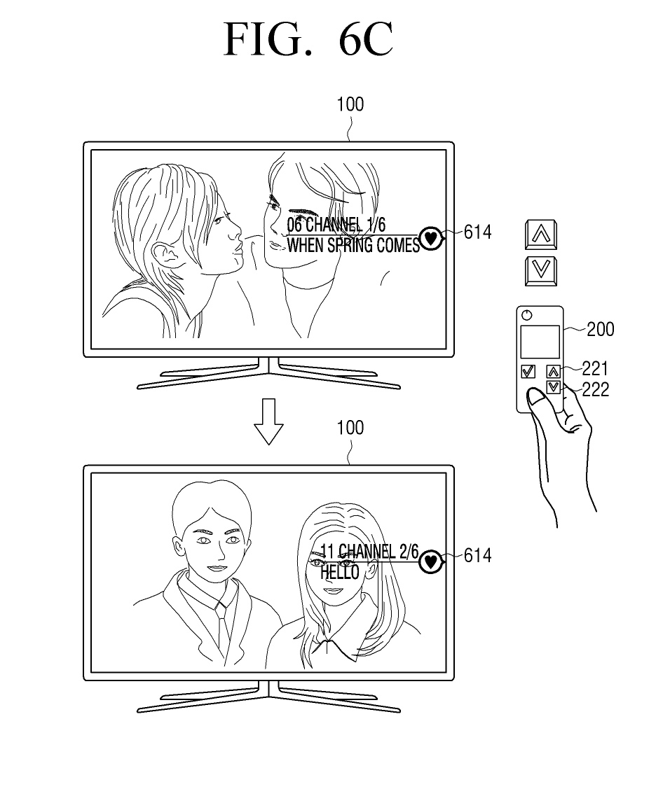

FIGS. 6A to 6C illustrate functions of a badge item according to an exemplary embodiment.

As shown in FIG. 6A, a user interface (UI), that includes badge items 611 to 615, may be provided on the screen/display of the display apparatus 100 according to a user command. In this case, the UI is rotatable, and according to rotation, a new badge item may be provided on the screen/display. For example, if a user inputs a rotation command through a touch pad incorporated in a remote controller, rotates the remote controller itself, or inputs a rotation command through a rotation motion or a rotation voice, etc., the badge items 611 to 615 disappear as the items rotate clockwise or counterclockwise, and new badge items may be displayed. A user interface (UI) that provides a new badge item according to scrolling, not described herein, may also be provided, but is not limited thereto.

On the other hand, a user command to provide the UI that includes the above-described badge items 611 to 615 may be a particular button incorporated in a remote controller, a particular motion of a user, and a voice of a user, according to an exemplary embodiment, but is not limited thereto.

Referring to FIG. 6B, if a particular badge item 614 is selected in the UI illustrated in FIG. 6A, contents that belong to the badge item 614 may be displayed in thumbnail form. In this case, a user may navigate the contents by using a channel up/down button equipped in the remote controller, but the method of navigation is not limited thereto and may incorporate voice commands, actions detected by a camera, and numerous other input methods well known to an artisan skilled in the art.

As illustrated, in a list of channels which can be searchable within the particular badge item 614, not only channels 622, 623, 625, and 626 on which programs are actually broadcast but also virtual channels 621 and 624 may be included, which do not broadcast programs. In this regard, the virtual channels may host an advertisement (AD), a video on demand (VOD), MUSIC, etc. For example, an advertisement corresponding to the characteristic of the badge item may be configured to be a separate channel, or a separate channel from which a user can view or search the badge item-related VOD may be created, according to an exemplary embodiment. Accordingly, the user may access the virtual channels naturally as the user changes the channels through the channel up/down button or via other forms of input.

As shown in FIG. 6C, in response to the particular badge 614 item being selected, contents that belong to the badge item 614 may be played on a screen in a full-screen mode, according to another exemplary embodiment. In this case, the user may select the corresponding contents by using channel up/down buttons 221 and 222 incorporated in the remote controller 200. In other words, if a channel zapping command is input after a badge item is selected, only contents that belong to the badge item may be selected and provided. The channel zapping command may be input in various forms such as a up/down button (for example, a up/down button of four-way keys), a motion, a voice, a movement of a pointer other than the channel up/down buttons, etc.

As shown in FIG. 6C, the selected badge item 614, information on the displayed contents, and information on the number of contents included in the badge item 614 may be provided on the screen.

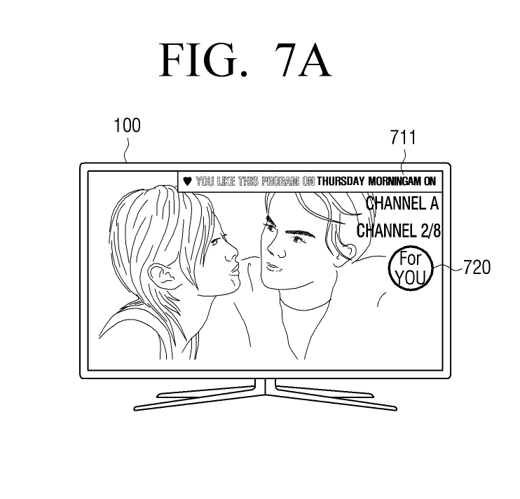

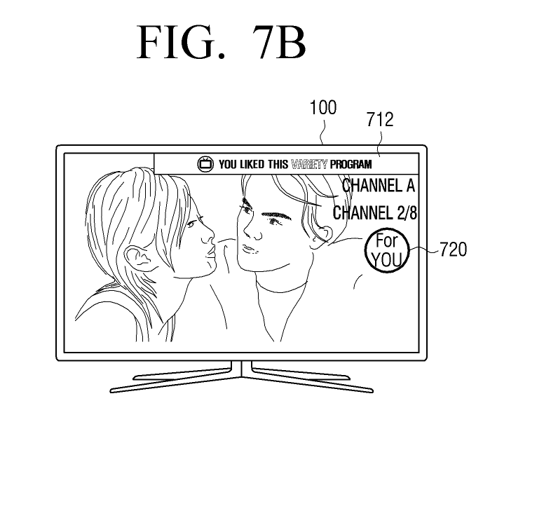

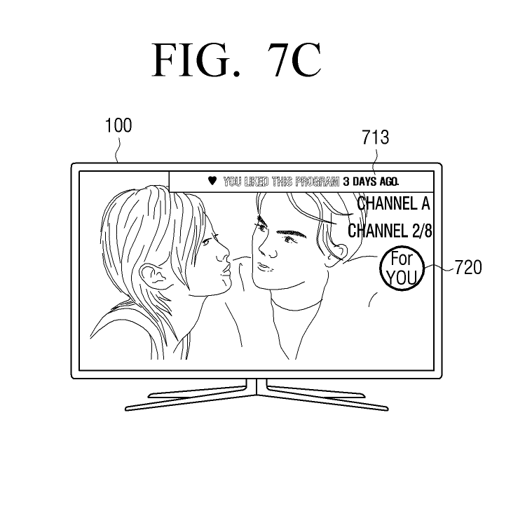

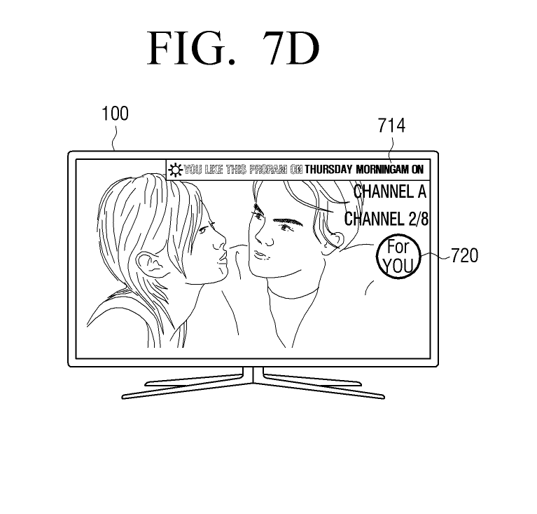

FIGS. 7A to 7D illustrate a method of providing a content according to another exemplary embodiment.

As shown in FIGS. 7A to 7D, a predetermined badge item and text information related to the badge item may be provided together on a screen in which the content is played. According to another exemplary embodiment, only text information without a badge item may be provided.

As shown in FIG. 7A, if a badge item selected by a user is a badge item 720, which provides the user preferred content, or provides a recommended content based on the user preference, not only the badge item 720, but also a reason for preference or a reason for recommendation may be provided in a form of text information 711 on the display/screen. In this case, the text information 711 may include another badge item in which the corresponding content is included. In other words, if the displayed content also belongs to the romance genre badge item, the romance badge item may be provided along with the text information, according to an exemplary embodiment. In addition, a keyword of the text information 711 may be displayed to distinguish the keyword text from other text. In this regard, the keyword is a point word that is a reason for preferring or recommending the corresponding content, and may include information on time, genre, cast, etc. The text information 711 may provide only text information, such as a reason for preference or recommendation, without another badge item.

Such text information may be embodied in various forms as shown in FIGS. 7B to 7D. FIG. 7B depicts the same selected badge item 720, but illustrates a different embodiment of text information 712 displayed on the display/screen. FIG. 7C depicts a different embodiment of text information 713 and FIG. 7D depicts yet another exemplary embodiment of text information 714.

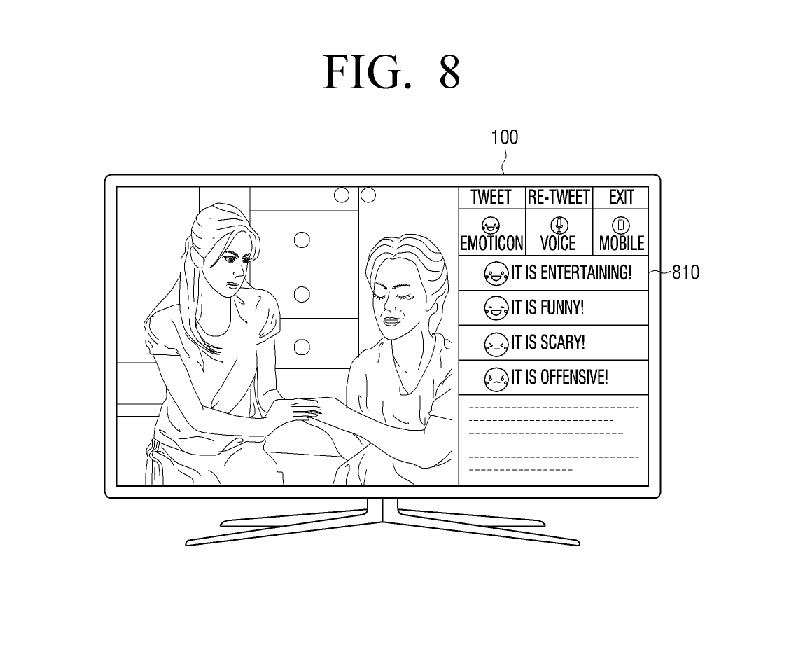

FIG. 8 illustrates a method of reflecting a user's opinion on content according to an exemplary embodiment.

As shown in FIG. 8, a user interface (UI) 810 may be provided in which a user may input the user's opinion regarding content displayed on an area of a screen. Moreover, the UI 810 may be provided to connect to the SNS server, according to an exemplary embodiment.

Specifically, the user may input the user's own emotional opinion by selecting an emoticon included in the UI 810 and the input opinion may be included in the content as additional information and may help another user later select the content. Furthermore, the input opinion may be uploaded to the SNS server and shared with another user.

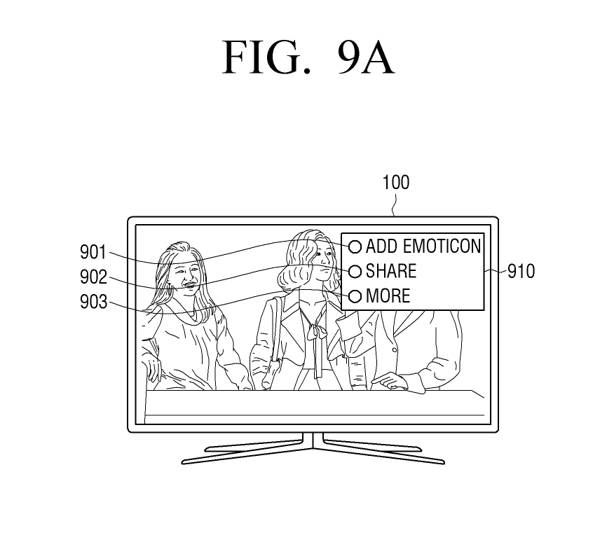

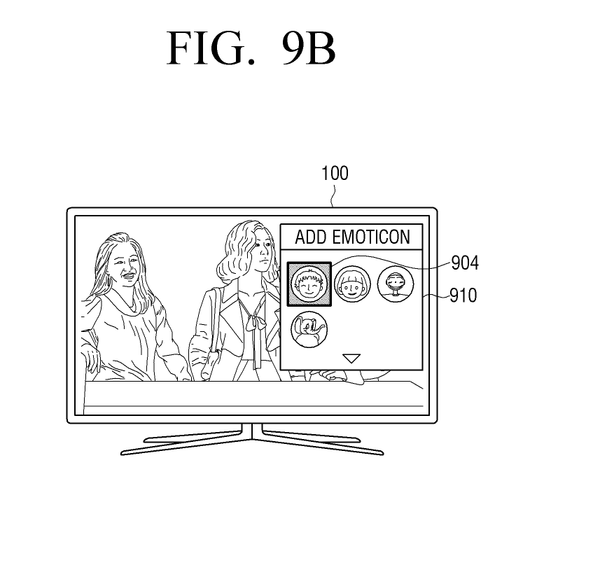

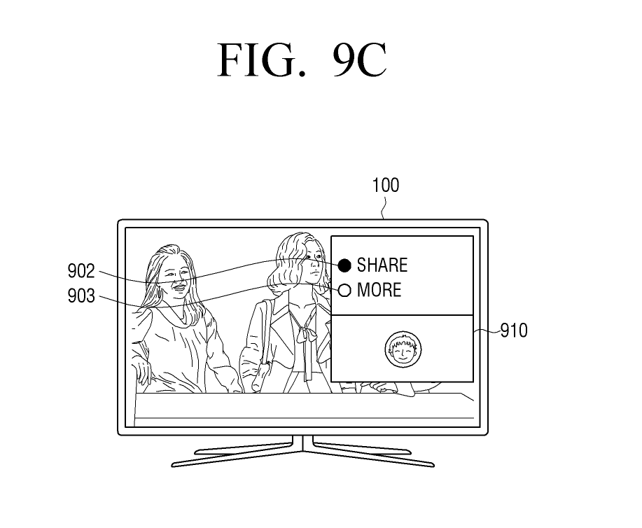

FIGS. 9A to 9C illustrate a method of inputting a check-in interaction for assigning an emoticon according to another exemplary embodiment. Hereinafter, descriptions overlapped with the above-described embodiments will not be repeated.

As shown in FIG. 9A, while content is being displayed, a check-in screen 910 may be displayed in an area of the screen. In this case, the check-in screen 910 may be an on screen display (OSD), according to an exemplary embodiment.

The check-in screen 910 incorporates at least one GUI for assigning an emoticon to the displayed content. Referring to FIG. 9A, a plurality of GUIs 901 to 903 are displayed on the check-in screen 910, and the user may select a first GUI 901 for selecting an emotion to assign to the displayed content. In this regard, the user may select one of the GUIs 901 to 903 by performing a touch operation on the touch pad of the remote controller 200. According to an exemplary embodiment, as shown in FIG. 9A, GUI 902 may provide functionality to share information regarding the displayed content on social networks and GUI 903 may provide access to other functions available to the user. However the described functionality is not limited thereto.

On the other hand, the plurality of GUIs 901 to 903 displayed on the check-in screen 910 may form different colors. In addition, colors for the plurality of GUIs 901 to 903 may correspond to a plurality of color buttons (not shown) formed in the remote controller 200. Accordingly, the user may select one GUI by selecting a color button on the remote controller 200 with a color corresponding to the GUI the user intends to select from the plurality of color buttons.

In FIG. 9B, functionality of the first GUI 901 is depicted.

When the first GUI 901 is selected, at least one or more emoticons may be displayed on the check-in display 910. In addition, a selection object 904 may be positioned on at least one of the displayed emoticons. The selection object 904 may be a GUI for selecting one of at least one or more displayed emoticons and assigning the selected emoticon to the displayed content.

Accordingly, as shown in FIG. 9B, in response to a plurality of emoticons being displayed, the selection object 904 may be positioned on the first emoticon. The user may position the selection object 904 on an emoticon the user wants to select by manipulating the touch pad of the remote controller 200.

Accordingly, if the user selects one emoticon, as shown in FIG. 9C, the selected emoticon is displayed on the check-in screen 910. In this regard, a second GUI 902 may be selected to transmit emoticon information assigned to the corresponding content to the external server 300. In other words, if the user selects the second GUI 902 in a state shown in FIG. 9C, content information signifying that the user has assigned a particular emoticon to a particular content may be transmitted to the external server 300. The external server 300 may be a Social Network Service (SNS) server, according to an exemplary embodiment. Similarly, content information signifying that other users have assigned a particular emoticon to a particular content may be transmitted to the external server 300.

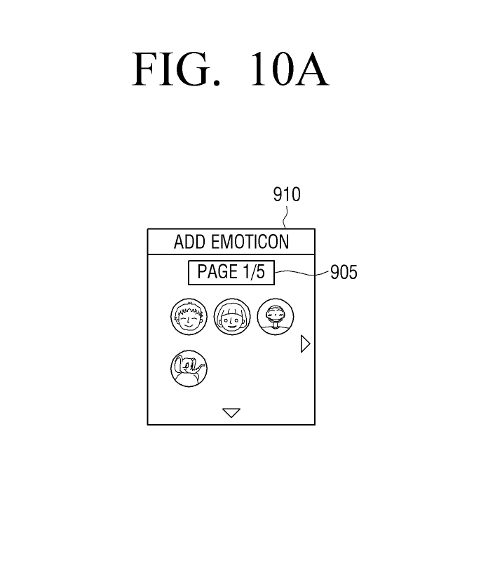

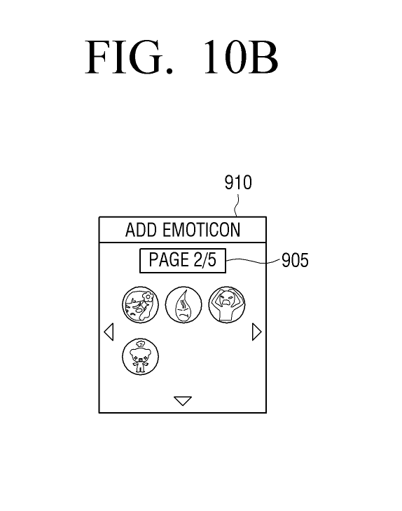

FIGS. 10A and 10B illustrate a method of emoticon classification according to an exemplary embodiment.

FIGS. 10A and 10B illustrate a case in which emoticons are grouped based on attributes of the emoticons. Specifically, the controller 140 may classify the emoticons into a plurality of groups based on attributes. For example, a first group may incorporate emoticons depicting joy, a second group may incorporate emoticons depicting sorrow, a third group may incorporate emoticons depicting anger, a fourth group may incorporate emoticons depicting astonishment, and a fifth group may incorporate emoticons depicting boredom, according to an exemplary embodiment. In this regard, it is desirable that the emoticon be included in a group corresponding to a general and immediate emotion a user may receive from the image.

FIG. 10A illustrates a scenario in which a plurality of emoticons included in the first group are displayed, and FIG. 10B illustrates a scenario in which a plurality of emoticons included in the second group are displayed.

The plurality of groups may be separated into several pages. For example, referring to FIG. 10A, the first group corresponds to a first page, and referring to FIG. 10B, the second group corresponds to a second page.

Meanwhile, a page display area 905 may be formed on the check-in screen 910 which shows the emoticon groups and the page number. A position of a currently displayed page may be displayed in number or text on the page display area 905, according to an exemplary embodiment. A category to which the corresponding group belongs may be displayed in text or via an image on the page display area 905. For example, an image of a smiling creature or the text “joy” may be displayed on the page display area 905.

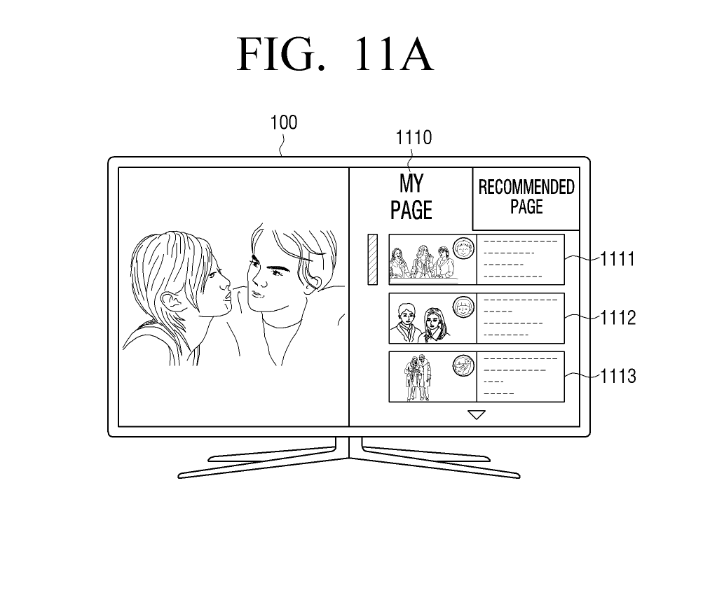

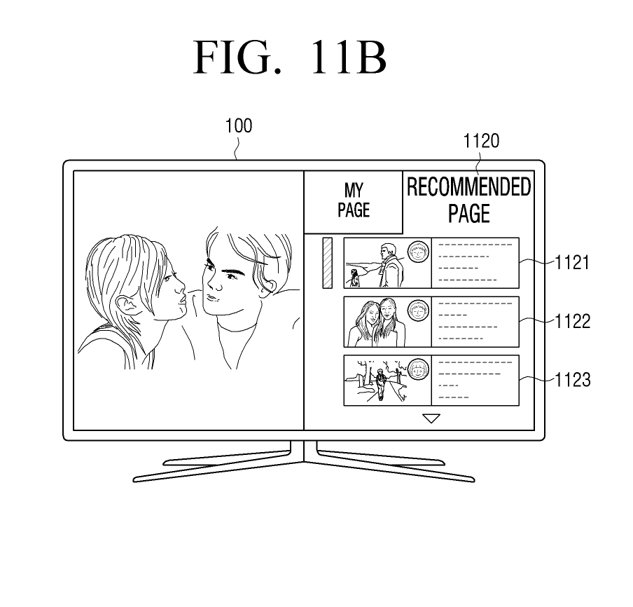

FIGS. 11A and 11B illustrate a method of providing information on content according to an exemplary embodiment.

FIG. 11A illustrates a case in which a user's history of emoticon input for a content is displayed in a list.

Referring to FIG. 11A, an area for My Page 1110 forms one portion of the display 110 or the display apparatus 100. At least one information area may be displayed on the area for My Page 1110, and information on a particular content may be displayed on the information area.

Specifically, a thumbnail for a first content may be displayed on one portion of a 1 to 1 information area 1111 incorporated within the My Page 1110 area, and information on the first content (for example, a production date, a producer, a cast, a running time, and a storyline) may be displayed on the other portion of the 1 to 1 information area 1111. In this regard, an emoticon that the user assigns to the first content may be displayed on one portion of the 1-1 information area 1111. Similarly, information area 1112 and 1113 may further be incorporated within the My Page 1110 area corresponding to other content to which the user previously input emoticons.

FIG. 11B illustrates a case in which other user's history of an emoticon input for a content is displayed in a list form. In this regard, the controller 140 may receive information on the emoticon selected by other users for a content, and display the emoticon selected by the other users on a predetermined area. In other words, the controller 140 may display the emoticon selected by the other users for a content being displayed with a thumbnail, and information on the content.

Referring to FIG. 11B, a recommendation page area 1120 forms one portion of the display 110 of the display apparatus 100. At least one information area may be formed on the recommendation page area 1120, and information on a particular content may be displayed on the information area.

Detailed descriptions of the information areas 1121, 1122 and 1123 are similar to the above-described information areas 1111, 1112 and 1113. In this regard, an emoticon assigned to the corresponding content by the other users may be displayed on one portion of the information area under the recommendation page area 1120.

The controller 140 may receive the number of other users who selected an emoticon for the content, and may display the number of the other users together on the predetermined area, according to another exemplary embodiment.

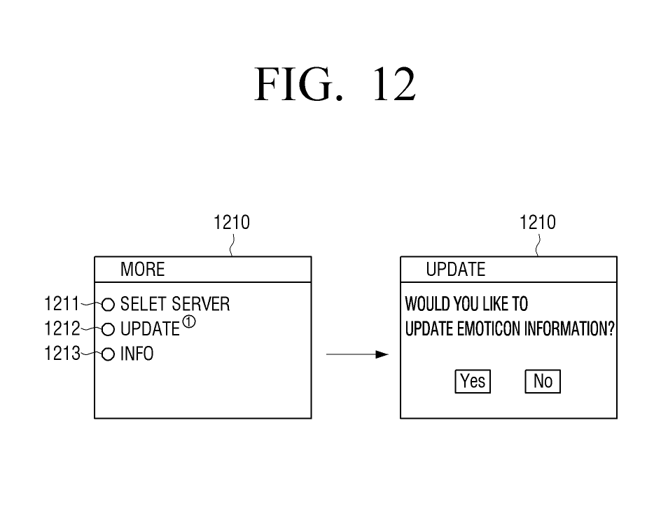

FIG. 12 illustrates a method of updating emoticon information according to an exemplary embodiment.

FIG. 12 illustrates a check-in screen 1210 in a scenario in which a user selects a third GUI 903 as shown in FIG. 9A.

Referring FIG. 12, if the user selects an update GUI 1212, a screen to allow the user to select whether to update emoticon information may be displayed on the check-in screen 1210. Accordingly, if the user selects the update of the emoticon information, the emoticon information stored in a memory may be updated. That is, the controller 140 may receive emoticon information from the external server 300, and update pre-stored emoticon information based on the newly received emoticon information.

The check-in screen illustrated in FIG. 12 is merely an example, and may be implemented in various different ways. GUI 1211 and GUI 1213 may provide other functions to the user, such as selecting an external server and obtaining information regarding previously saved input from the user respectively, but is not limited thereto.

As described above, emotions of a user for a content may be immediately displayed by assigning a selected emoticon to content being displayed.

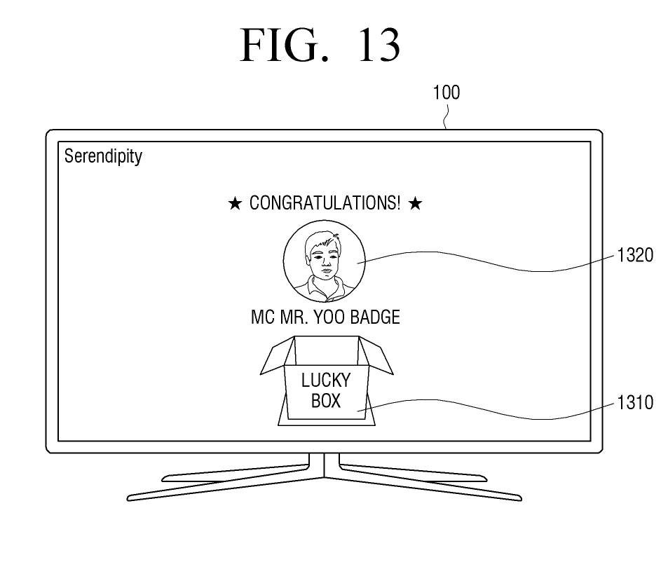

FIG. 13 illustrates a method of providing a reward according to an exemplary embodiment.

As shown in FIG. 13, a badge item may be provided in a reward form based on a user's history of check-in interactions. For example, if a level of a badge item incremented based on the check-in interaction frequency, a lucky box 1310 that incorporates point rewards may be provided and an event badge item 1320 may be provided by drawing lots upon executing the lucky box 1310.

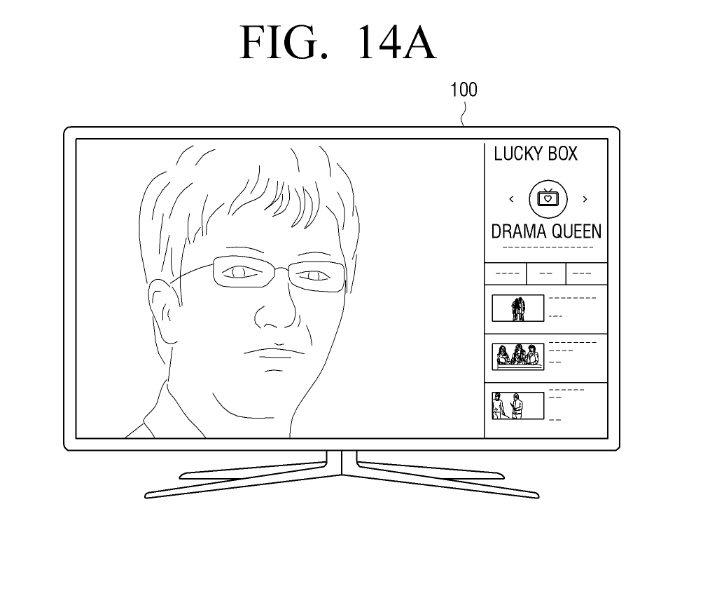

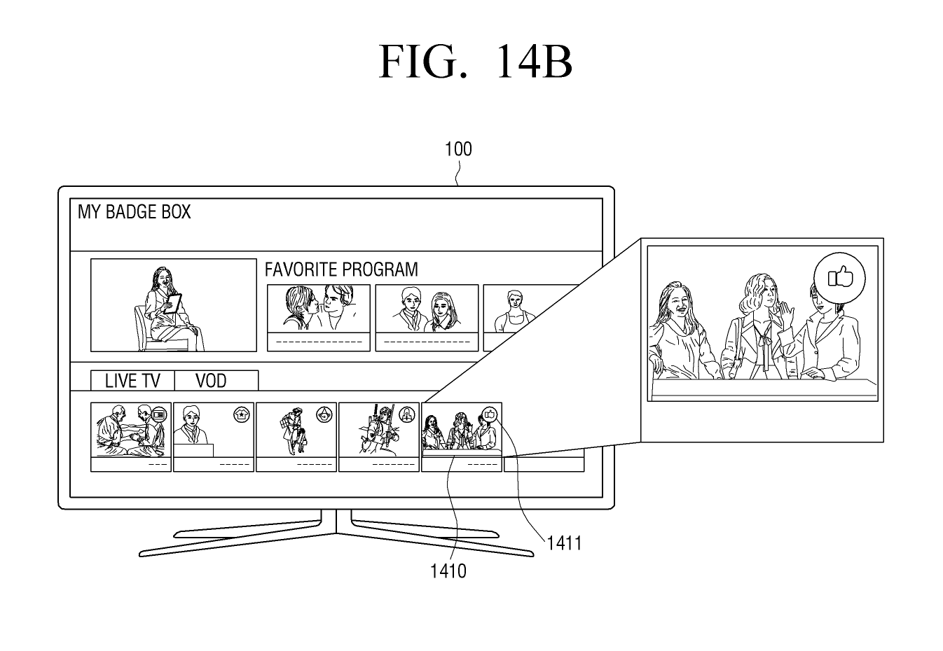

FIGS. 14A and 14B illustrate a method of providing a user interface (UI) according to an exemplary embodiment.

As shown in FIGS. 14A and 14B, a badge box that provides various types of information on a badge item may be provided, according to an exemplary embodiment.

Specifically, as shown in FIG. 14A, a UI may be provided on a portion of a screen, or as shown in FIG. 14B, the UI may be provided on the whole area of the screen.

Referring to FIG. 14B, the UI that exhibits the badge box of the user provided by a log-in may be provided with the information on a recommendation content 1410 recommended based on the badge item retained by the user. In this regard, a badge item 1411 that shows the recommendation may be provided for the corresponding recommendation content 1410. In addition, it may be possible to display a badge item that is a base for recommending the corresponding recommended content 1410 together, according to an exemplary embodiment. For example, if another episode of a program that belongs to a badge item the user retains is recommended as a recommended content, the badge item to which the corresponding program already belongs to may also be provided.

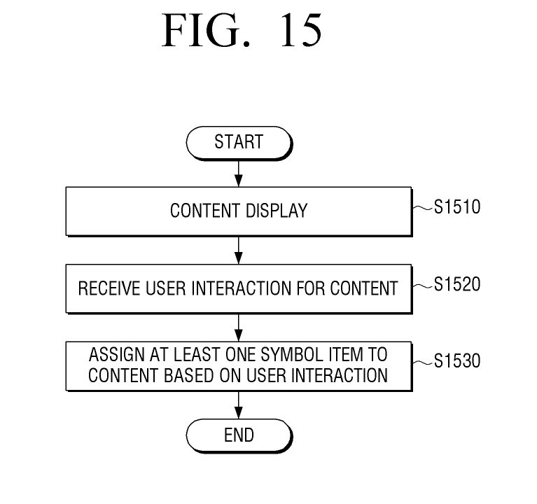

FIG. 15 is a flow chart illustrating a controlling method of a display apparatus according to an exemplary embodiment.

According to the controlling method of the display apparatus illustrated in FIG. 15, a content is displayed (S1510).

Following that, user interaction regarding the content is received (S1520). In this regard, the user interaction for the content may incorporate at least one from among the content itself, attributes of the content, and at least one object included in the content.

Subsequently, based on the user interaction, at least one symbol item is assigned to the content, and the content is provided based on the symbol item assigned to the content according to a predetermined event. (S1530).

In this regard, the symbol item may be at least one from among a badge item, which represents common attributes of at least one or more contents, and an emoticon item, which represents emotions of a user.

In addition, the controlling method of the display apparatus may further include storing a history of user interaction, and in the step of S1530, a badge item corresponding to at least one attribute of the content based on the stored history may be provided, and in response to the badge item being selected, a content which belongs to the badge item may be selected and provided.

Furthermore, the controlling method of the display apparatus may further include, in response to a channel zapping command being input in a state where the badge item is selected, queuing and providing only a content/channel belonging to the selected badge item.

Moreover, the controlling method of the display apparatus may further include providing feedback information of other users regarding a content that belongs to a badge item based on other user's interaction information regarding the content uploaded to a SNS server.

In addition, the method may further include incrementing a level of the badge item in response to a predetermined condition being met based on the history, and providing a predetermined point in response to the level of the badge item being incremented.

Furthermore, the method may include providing an event badge item based on the predetermined point.

In this regard, the user interaction for the content may include user interaction for at least one from among the content itself, attributes of the content, and at least one object included in the content.

The method of providing a content may provide a user interface (UI), which is rotatable on one side of a screen according to a predetermined event, and provides a new badge item according to rotation, and in response to a particular badge item being selected, a content that belongs to the selected badge item may be displayed in the form of a thumbnail.

Furthermore, the method may include displaying a user interface (UI) screen including at least one or more emoticon items, and in response to selection of one from among at least one or more emoticon items based on the user interaction input, assigning information corresponding to the selected emoticon item to the displayed content.

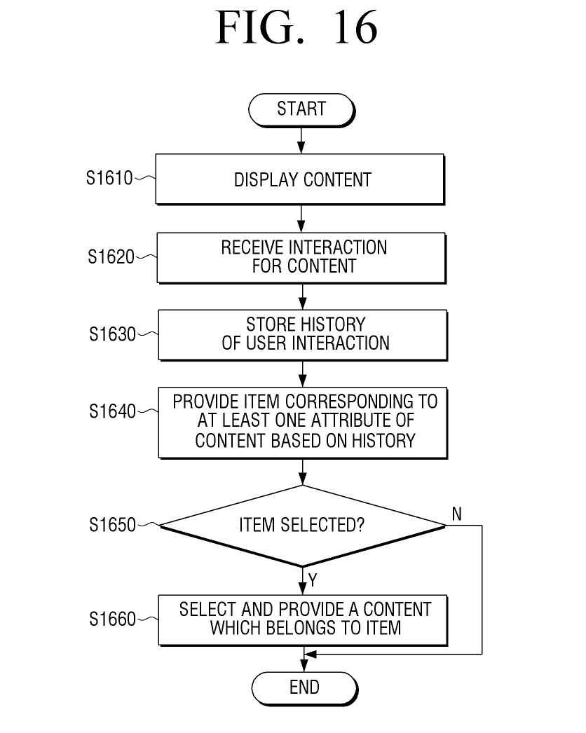

FIG. 16 is a flow chart illustrating a controlling method of a display apparatus according to another exemplary embodiment.

According to the controlling method of a display apparatus illustrated in FIG. 16, content is displayed (S1610), and user interaction regarding the content is received (S1620).

Following that, a history of the user interaction is stored (S1630), and an item corresponding to at least one attribute of the content is provided based on the stored history (S1640).

Subsequently, in response to one item being selected from among the provided items (S1650:Y), a content that belongs to the selected item is selected and provided (S1660). However, if none of the provided items are selected (S1650:N) the no further action is taken and the process comes to an end.

In this regard, an item may be a badge item, which symbolically represents common attributes of at least one content which belongs to the item, according to an exemplary embodiment.

In addition, the method of providing a badge item according to an exemplary embodiment may be embodied to be performed by an application a user directly uses on an Operating System (O/S). In addition, the application may be provided in the form of an icon interface on a screen of the display apparatus 100, but is not limited thereto.

Therefore, as described above, a user may be provided with abundant TV viewing experiences.

However, according to the above-described exemplary embodiment, various operations are performed in the display apparatus, but various operations related to a badge item may be performed in a server that instead communicates with a display apparatus, according to another exemplary embodiment.

Meanwhile, the controlling method of a display apparatus according to various exemplary embodiments may be embodied as a program code that can be executed by a computer, and provided to each server or device to be executed by a process while being stored in various types of a non-transitory computer readable medium.

For example, a non-transitory computer readable medium that stores a program which, in response to a user interaction regarding a content being received, stores a history of the user interaction, and provides an item corresponding to at least one attribute of the content based on the history, and in response to the item being selected, selects and provides a content which belongs to the selected item.

Specifically, the above-described various types of applications or programs may be stored in the non-transitory readable medium such as be a compact disc (CD), a digital versatile disk (DVD), a hard disk, a Blu-ray disk, a universal serial bus (USB), a memory card, and a read only memory (ROM).

The foregoing exemplary embodiments and advantages are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to display content;
a user interface configured to receive user interaction regarding the content; and
a controller configured to assign at least one symbol item to the content based on the user interaction and to provide the content from among a plurality of contents based on the symbol item assigned to the content.

2. The apparatus as claimed in claim 1, wherein the symbol item is at least one of a badge item that represents common attributes of at least one second content from among the plurality of contents and an emoticon item that represents emotions of a user.

3. The apparatus as claimed in claim 2, further comprising:
a memory configured to store a history of the user interaction,
wherein the controller is further configured to provide the badge item corresponding to at least one attribute of the at least one second content from among the plurality of contents based on the history, and in response to the badge item being selected, selects and provides at least one of the at least one second content corresponding to the badge item.

4. The apparatus as claimed in claim 3, wherein the badge item includes at least one of a content genre badge, a content program badge, a content cast badge, a content view pattern badge, and a check-in badge.

5. The apparatus as claimed in claim 2, wherein in response to a channel zapping command being input in a state in which the badge item is selected, the controller selects and provides a channel corresponding to the badge item.

6. The apparatus as claimed in claim 2, wherein user interaction comprises user input regarding at least one of the content itself, attributes of the content, and at least one object included in the content.

7. The apparatus as claimed in claim 2, further comprising:
a communicator configured to communicate with a social networking service (SNS) server,
wherein based on user interaction information of other users regarding the content, which is uploaded to the SNS server, the controller is further configured to provide feedback information of other users regarding the at least one second content corresponding to the badge item.

8. The apparatus as claimed in claim 2, wherein the controller is further configured to provide at least one of a user interface (UI) which is rotatable and provides a new badge item according to rotation, and a user interface (UI) which is scrollable and provides a new badge item according to scrolling on an area of the screen according to a predetermined event, and in response to a particular badge item being selected, displays corresponding content which belongs to the selected badge item.

9. The apparatus as claimed in claim 8, wherein in response to a particular badge item being selected in the UI, the controller is further configured to provide the corresponding content by selecting a channel that provides the content corresponding to the selected badge item.

10. The apparatus as claimed in claim 2, wherein in response to a UI screen that includes at least one emoticon item being displayed, and in response to the at least one emoticon item being selected based to the user interaction, the controller assigns information corresponding to the selected emoticon item to the displayed content.

11. The apparatus as claimed in claim 10, wherein the controller displays the UI screen that groups the emoticon items based on attributes of the emoticon items on an area of the display.

12. The apparatus as claimed in claim 2, wherein the controller is further configured to receive information regarding the content and an emoticon selected regarding the content by other user from an external server based on a predetermined event, and displays the received information on a predetermined area of the display.

13. The apparatus as claimed in claim 12, wherein the controller is further configured to receive information on a number of other users who select an emoticon item for the content, and is further configured to display the number of the other users on the predetermined area.

14. The apparatus as claimed in claim 1, wherein the controller is further configured to provide the content by displaying the symbol item on an area of a thumbnail based on the predetermined event.

15. The apparatus as claimed in claim 1, wherein the controller is further configured to provide at least one of the symbol item and text information corresponding to the symbol item on an area of the display which displays the content.

16. A method of controlling a display apparatus, comprising:
displaying content;
receiving user interaction regarding the content; and
assigning at least one symbol item to the content based on the user interaction, and providing the content from among a plurality of contents based on the symbol item assigned to the plurality of contents.

17. A display apparatus comprising:
a display configured to display content;
a user interface configured to receive user input representing a user's emotion towards an attribute of the content; and
a memory configured to store the received user input.

18. The display apparatus of claim 17, further comprising:
a controller configured to assign at least one symbol item to the content based on the user input.

19. The display apparatus of claim 18, wherein the controller is further configured to select the content from among a plurality of contents based on respective symbol items assigned to the plurality of content and to provide the selected content to a user.

20. The display apparatus of claim 18, wherein assigning the at least one symbol item comprises assigning the displayed content to a group of other contents which share similar attributes with the displayed content.
